(19) United States
(12) Patent Application Publication
(10) Pub. No.: US 2011/0270493 A1
(43) Pub. Date: Nov. 3, 2011

(54) SEAT-BELT-RETRACTOR CONTROL DEVICE AND SEAT BELT DEVICE HAVING THE SAME

(75) Inventor: Koji TANAKA, Tokyo (JP)

(73) Assignee: TAKATA CORPORATION

(21) Appl. No.: 13/092,750

(22) Filed: Apr. 22, 2011

(30) Foreign Application Priority Data
Apr. 28, 2010 (JP) 2010/103899

(51) Int. Cl. B60R 22/48

(52) U.S. Cl. 701/45

(57) ABSTRACT

To produce a compact torque limiter mechanism at low cost while improving the durability of the torque limiter mechanism. An ECU 25 stops power supply to the motor 16 when it determines that a buckle switch 27 has detected engagement between a tongue and a buckle, that a seat-belt tension-control function is operating according to an output signal from an MSB-function operating-condition-signal output portion 26, and that the motor current detected by an ammeter 24 is equal to or larger than the preset current set in advance. Then, an ELR function is activated, and a seat belt 4 restrains an occupant. This prevents the torque limiter mechanism from being activated, thereby reducing the activation frequency of the torque limiter mechanism and improving the durability of the torque limiter mechanism.

### TECHNICAL FIELD

The present invention relates to a technical field of a control device for a seat belt retractor that is configured as a motor retractor for performing winding and withdrawing of a seat belt by transmitting the motive power of a motor to a spool via a power transmission mechanism and a torque limiter and that protects the power transmission mechanism and the motor by blocking a load equal to or larger than a predetermined value (a counter force) exerted by the seat belt with the torque limiter, and a seat belt device having the same.

### BACKGROUND

A seat belt device attached to a seat of a vehicle, such as a car, includes a seat belt retractor for winding a seat belt on a spool. Conventionally, various emergency locking retractors (hereinafter also referred to as “ELR”), which are the seat belt retractors of this type, have been developed. Such a seat belt retractor has an emergency locking function (ELR function) in which, in an emergency where a large deceleration occurs in a vehicle, such as a vehicle collision, the deceleration is detected, and a locking mechanism prevents the spool from being rotated in a belt-withdrawing direction, thereby preventing a seat belt from being withdrawn by an occupant who is moving forward due to inertia. By the activation of this ELR function, the seat belt effectively restrains the occupant.

Furthermore, in the conventional seat belt retractors, there have been proposed various motor retractors (hereinafter also referred to as “MSBs”) which have, in addition to the above-mentioned ELR function, a seat-belt tension-control function (hereinafter referred to as an “MSB function”) in which winding and withdrawing of the seat belt is performed by transmitting the motive power of the motor to the spool via the power transmission mechanism, thereby controlling the tension of the seat belt (for example, see PTL 1). In the MSB function, the current flowing in the motor is controlled according to the driving conditions, operating conditions, etc., of the vehicle. In this case, once the motor current reaches a preset value set in advance while the MSB function is operating, the motor current is controlled at this preset value until activation of the MSB function is terminated. In other words, as shown by a solid line a in FIG. 6, when the seat belt winding is performed using the MSB function, once a load F (N) input to the power transmission mechanism has reached a preset load Fu (N) set in advance corresponding to the preset current, the load F (N) input to the power transmission mechanism is controlled at this preset load Fu (N) until activation of the MSB function is terminated.

Seat belt winding using the MSB function is performed when seat belt winding according to the driving conditions, operating conditions, etc., of a vehicle is needed; for example, when a seat belt is wound to warn an occupant, when a seat belt is wound to lightly restrain an occupant during sport driving or high-speed driving, and when a seat belt is would to relatively strongly restrain an occupant when a vehicle is likely to collide with an object in front of the vehicle (for example, a forward vehicle) or when the vehicle will inevitably collide with this object (for example, a forward vehicle). Furthermore, seat belt winding using the MSB function is also performed when the seat belt is wound to wind the withdrawn seat belt when an occupant cancels the wearing of the seat belt to leave the car.

Meanwhile, when a vehicle is subjected to a deceleration while an MSB is performing seat belt winding using the MSB function, a load equal to or larger than a predetermined value may be exerted as a counter force from the seat belt to the power transmission mechanism, as shown by a dashed line b in FIG. 6. To protect the power transmission mechanism and the motor from this large load, the strength of the power transmission mechanism has to be increased. However, simply increasing the strength of the power transmission mechanism results in an increase in size of the power transmission mechanism.

Accordingly, in the MSB disclosed in PTL 1, a torque limiter mechanism is provided in the power transmission mechanism. This torque limiter mechanism blocks transmission of the power when a load F (N) equal to or larger than a torque limiter load Fl (N) set in advance is input from a seat belt to the power transmission mechanism, thereby preventing input of a large load to the power transmission mechanism and the motor. That is, as shown by a one-dot chain line c in FIG. 6, once the load F (N) applied to the power transmission mechanism has reached the torque limiter load Fl (N), the torque limiter mechanism is activated. As a result, the load F (N) applied to the power transmission mechanism is limited to a value less than the torque limiter load Fl (N). In this case, the above-described preset load Fu (N) is set to a value less than the torque limiter load Fl (N). This torque limiter mechanism protects the power transmission mechanism and the motor from a large load exerted by the seat belt and prevents an increase in size of the power transmission mechanism. Note that the load shown by two-dot chain line d in FIG. 6 is a seat belt load.

Meanwhile, when seat belt winding using the MSB function is performed to store a seat belt after an occupant has cancelled the wearing of the seat belt, the motor current increases after the entire seat belt is wound. Another proposed MSB stops power supply to the motor when the motor current reaches or exceeds a locking current set in advance, by regarding it as a completion of winding of the seat belt (for example, see PTL 2).

### [Citation List]

### [Patent Literature]

[PTL 1] Japanese Unexamined Patent Application Publication No. 2004-42788

[PTL 2] Japanese Unexamined Patent Application Publication No. 2007-55308

### SUMMARY

However, when a seat belt exerts a large load on the power transmission mechanism during seat belt winding using the MSB function disclosed in the above-described PTL 1, a load input to the power transmission mechanism is likely to be larger than the torque limiter load Fl (N) because of the load exerted by activation of the MSB function and the load exerted by the seat belt. Therefore, when a vehicle is decelerated while the MSB function is operating, the torque limiter mechanism is frequently activated.

As has been described, in the conventional seat belt retractor, not only that the torque limiter mechanism is frequently activated, but also that the torque limiter load Fl (N) is large because it must be equal to or larger than the load exerted by activation of the MSB function. Thus, it cannot be said that the torque limiter mechanism has excellent durability. Although one option for satisfying such a load requirement and a durability requirement to improve the durability of the torque limiter mechanism may be to increase the size of the torque limiter mechanism, such an increase in size of the torque limiter mechanism causes problems of increased installation space and high costs.

Furthermore, in the MSB disclosed in PTL 2, when seat belt winding using the MSB function is performed to store the seat belt after the wearing of the seat belt is cancelled, in other words, after a buckle switch is turned off, power supply to the motor is stopped when the motor current reaches the locking current. However, the MSB disclosed in PTL 2 does not have a torque limiter mechanism as disclosed in PTL 1 and, thus, preventing an excessive force (a counter force) exerted by the seat belt from being input to the power transmission mechanism, when an occupant wearing the seat belt is subjected to inertia, is not considered.

The present invention has been made in view of the above-described circumstances, and an object thereof is to provide a seat-belt-retractor control device and a seat belt device having the same in which a compact torque limiter mechanism can be formed at low cost, while improving the durability of the torque limiter mechanism.

To solve the above-described problems, a seat-belt-retractor control device includes, at least: a spool on which a seat belt is wound; a locking mechanism that normally allows the spool to rotate in seat-belt winding/withdrawing directions and locks the rotation of the spool in the seat-belt withdrawing direction in an emergency; a motor that rotates the spool by motive power to control the tension of the seat belt; a power transmission mechanism that transmits the motive power of the motor to the spool; and a torque limiter mechanism that is activated when the load input to the power transmission mechanism exceeds a torque limiter load set in advance and blocks transmission of the power by the power transmission mechanism, the seat-belt-retractor control device having an emergency locking function that locks withdrawing of the seat belt with the locking mechanism in an emergency and a seat-belt tension-control function that performs winding and withdrawing of the seat belt by the motor during the tension control of the seat belt. The seat-belt-retractor control device includes, at least: a tongue-buckle engagement detecting member that detects the engagement between a tongue and a buckle; an ammeter that detects the motor current flowing through the motor; a seat-belt tension-control-function operating-condition-signal output portion that outputs a seat-belt tension-control-function operating-condition signal; and a control unit that controls power supply to the motor. The control unit stops power supply to the motor when it determines that the tongue-buckle engagement detecting member has detected engagement between the tongue and the buckle, that the seat-belt tension-control function is operating according to the output signal from the seat-belt tension-control-function operating-condition-signal output portion, and that the motor current detected by the ammeter is equal to or larger than the preset value set in advance.

Furthermore, a seat belt device of the present invention for restraining an occupant includes, at least, a seat-belt-retractor control device that includes a seat belt retractor for winding a seat belt, and a control unit for controlling the seat belt retractor; a tongue supported in a freely slidable manner by the seat belt withdrawn from the seat belt retractor; and a buckle with which the tongue is engaged in an attachable/detachable manner. The seat belt retractor is the seat belt retractor of the above-described present invention. The seat-belt-retractor control device is the seat-belt-retractor control device of the above-described present invention.

In the thus-configured seat-belt-retractor control device of the present invention, the torque limiter mechanism is provided. Furthermore, the control unit stops power supply to the motor when it determines that the tongue-buckle engagement detecting member has detected engagement between the tongue and the buckle, that the seat belt is being wound by the operation of the seat-belt tension-control function, and that the motor current is equal to or larger than the preset value. Thereafter, the locking mechanism is activated, and the occupant is restrained by the seat belt. Thus, because a large load from the seat belt is not input to the power transmission mechanism, it is possible to prevent a load equal to or larger than the torque limiter load from being input to the power transmission mechanism. Accordingly, activation of the torque limiter mechanism can be prevented, and the activation frequency of the torque limiter mechanism can be reduced compared with the conventional torque limiter mechanism, which is activated by an excessive force (a counter force) exerted from the seat belt on the power transmission mechanism, due to the inertial force of the occupant, when the seat belt is relatively tightly wound to perform an emergency operation, such as a sudden braking operation.

Accordingly, the activation frequency of the torque limiter mechanism can be effectively reduced as described above, and the durability of the torque limiter mechanism can be improved. Thus, a compact torque limiter mechanism can be produced at low cost.

Meanwhile, according to the seat belt device having the seat-belt-retractor control device, because the durability of the torque limiter mechanism is improved, long-term effective restraining of occupants depending on the situation becomes possible. Furthermore, because the torque limiter mechanism can be made compact, the seat belt retractor can also be made compact. Thus, the arrangement flexibility of the seat belt retractor in the vehicle compartment can be improved.

### BRIEF DESCRIPTION OF DRAWINGS

FIG. 1 is a diagram schematically showing a seat belt device having an exemplary seat-belt-retractor control device according to an embodiment of the present invention.

FIG. 2 is a cross-sectional view schematically showing a seat belt retractor of the example shown in FIG. 1.

FIG. 3 is a perspective view showing a power transmission mechanism of the seat belt retractor of the example shown in FIG. 1.

FIG. 4 is a block diagram of the seat-belt-retractor control device of the example shown in FIG. 1.

FIG. 5 is a diagram showing a flow of a method for controlling the load applied to the power transmission mechanism of the example shown in FIG. 1.

FIG. 6 is a diagram for explaining the control of a load input to the conventional power transmission mechanism.

### DESCRIPTION OF EMBODIMENTS

An embodiment of the present invention will be described below using the drawings.

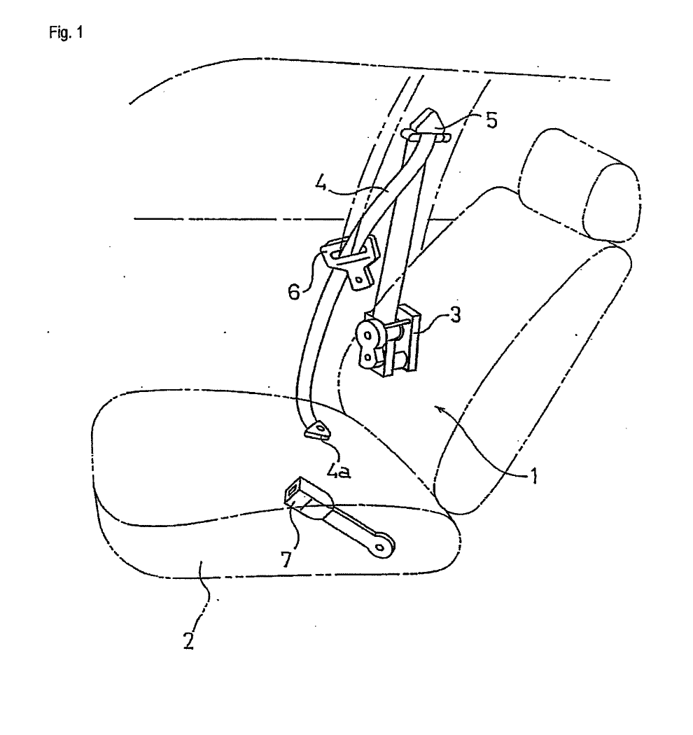

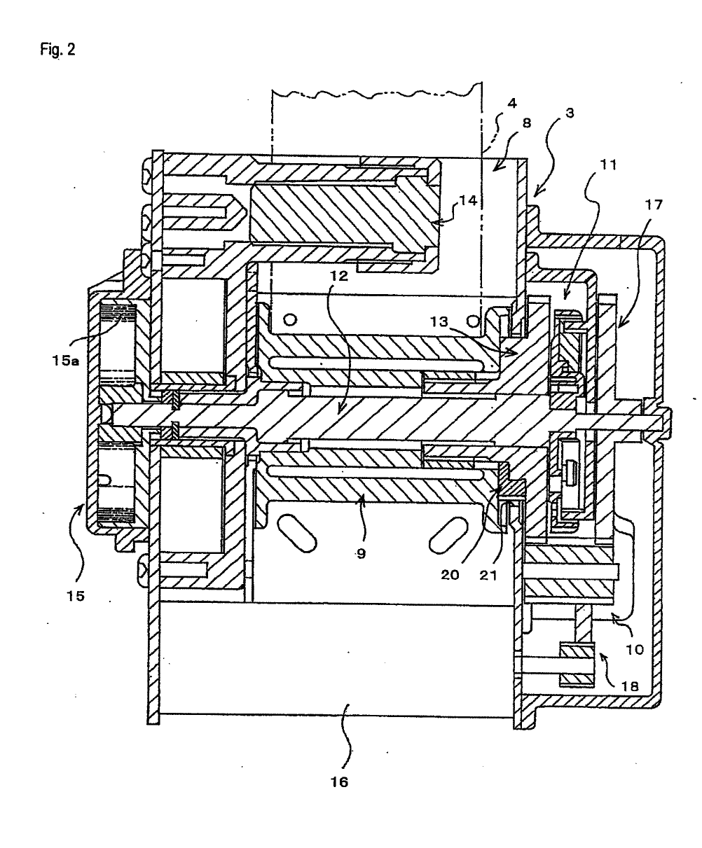

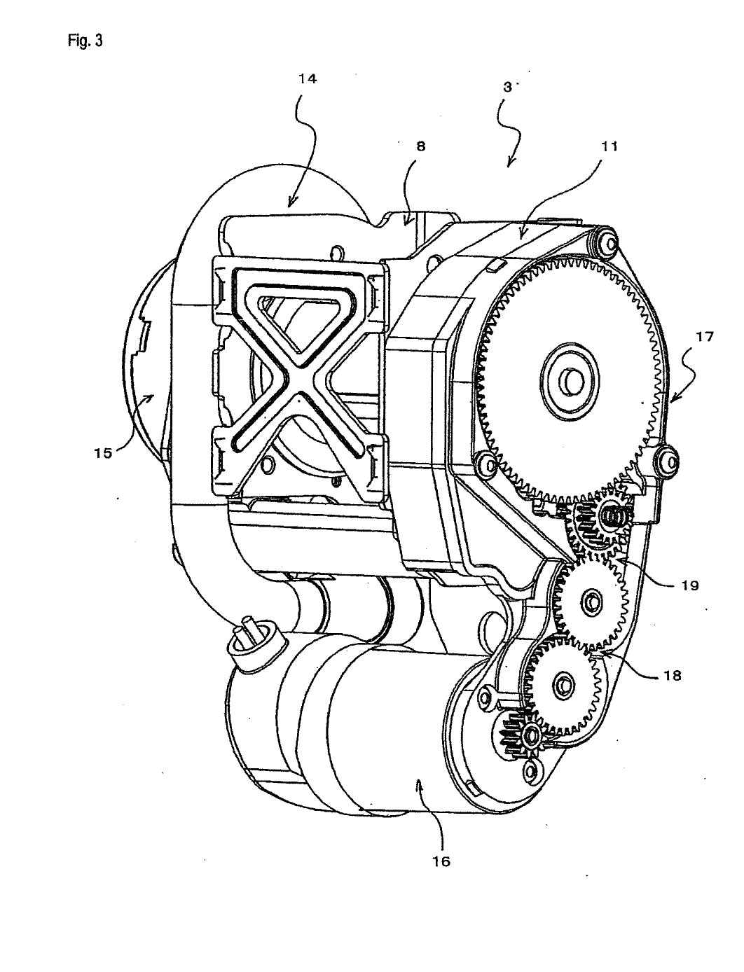

FIG. 1 is a diagram schematically showing a seat belt device having an exemplary seat belt retractor according to an embodiment of the present invention, FIG. 2 is a cross-sectional view schematically showing the seat belt retractor of the example shown in FIG. 1, and FIG. 3 is a perspective view showing a power transmission mechanism of the seat belt retractor of the example shown in FIG. 1.

As shown in FIG. 1, a seat belt device 1 of this example is basically the same as a conventional known three-point seat belt device. In the figure, 1 denotes a seat belt device, 2 denotes a vehicle seat, 3 denotes a seat belt retractor disposed near the vehicle seat 2, 4 denotes a seat belt that is wound on the seat belt retractor 3 so as to be capable of being withdrawn and that is fixed to the floor of a vehicle body or the vehicle seat 2 at a belt anchor 4a at the tip, 5 denotes a guide anchor that guides the seat belt 4 withdrawn from the seat belt retractor 3 toward a shoulder of an occupant, 6 denotes a tongue supported by the seat belt 4 guided by the guide anchor 5 in a freely slidable manner, and 7 denotes a buckle that is fixed to the floor of the vehicle body or the vehicle seat and to which the tongue 6 is inserted and fastened in an attachable/detachable manner.

The wearing operation and removal operation of the seat belt 4 of this seat belt device 1 are the same as those of the conventional known seat belt device.

As shown in FIGS. 2 and 3, the seat belt retractor 3 of this example is an ELR motor retractor that also performs winding and withdrawing of the seat belt 4 by driving of the motor (hereinafter also referred to as “MSB”) (hereinafter, the seat belt retractor 3 of this example is also referred to as “MSB3”). Therefore, this MSB3 has both the MSB function and the ELR function, similarly to the above-described conventional ones. Note that the seat belt retractor of the present invention is not limited to this, and it may be formed of another MSB or a conventionally known, motor-driven automatic locking seat belt retractor (ALR).

The basic configuration and basic operation of the MSB3 of this example are the same as the MSB disclosed in Japanese Patent No. 4379783. Therefore, the detailed descriptions thereof will be omitted because they can be easily understood by referring to the publication of Japanese Patent No. 4379783. Herein, the same configuration and operation will be briefly described.

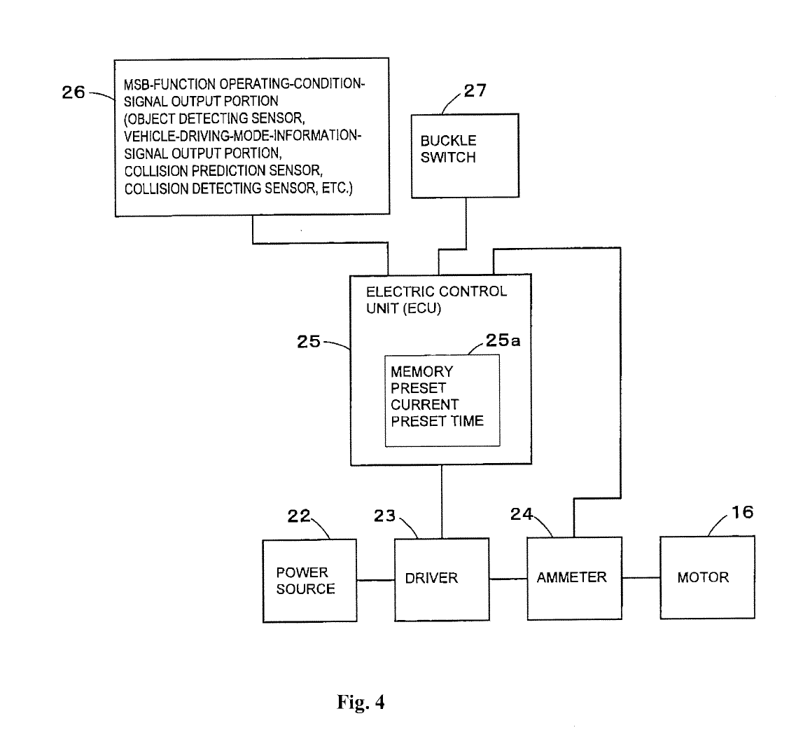

In FIGS. 2 and 3, 8 denotes a frame, 9 denotes a spool, 10 denotes a deceleration detecting mechanism, 11 denotes a locking mechanism, 12 denotes a torsion bar, 13 denotes a locking base, 14 denotes a pretensioner, 15 denotes a spring unit, 16 denotes a motor (electric motor), 18 denotes a power transmission mechanism, 19 denotes a torque limiter mechanism, 20 denotes a pawl, and 21 denotes an internal gear. Note that, the pretensioner 14 and the motor 16 are both controlled by an electric control unit (ECU) 25 (shown in FIG. 4 described below), which is a seat-belt-retractor control device of the present invention.

The basic operation of the MSB3 of this example will be described.

In a non-worn state of the seat belt 4, the spool 9 is urged in the seat belt winding direction by an urging force of a spring 15a of the spring unit 15. Thus, the entirety or substantially the entirety (the amount of the seat belt 4 that can be wound in a non-worn state) of the seat belt 4 is wound on the spool 9.

When the seat belt 4 is pulled at a normal speed for wearing, the spool 9 is rotated in the seat-belt withdrawing direction, and the seat belt 4 is withdrawn. When the tongue 6 is inserted into and fastened with the buckle 7, the occupant wears the seat belt 4. Furthermore, when the tongue 6 is inserted into and fastened with the buckle 7, a buckle switch 27 (shown in FIG. 4 described below) is turned on, and an ECU 25 brings the motor 16 into a drivable state according to an on-signal from the buckle switch 27. Then, the motor 16 is driven and the excessively withdrawn seat belt 4 is wound on the spool 9 to such an extent that the occupant does not feel tightness. Thus, the slack of the seat belt 4 is removed while providing a comfortable state in which the occupant is not strongly restrained by the seat belt.

In the initial stage of the above-described emergency, the pretensioner 14 is activated to generate a seat belt winding torque. This seat belt winding torque causes the spool 9 to wind a predetermined amount of the seat belt 4, thereby removing the slack of the seat belt 4. Thus, the seat belt 4 restrains the occupant quickly. Meanwhile, the deceleration detecting mechanism 10 is activated due to a significant vehicle deceleration occurring in an emergency, activating the locking mechanism 11. That is, the pawl 20 of the locking mechanism 11 is turned and is engaged with the internal gear 21 on the side wall of the frame 8. That is, the ELR function of the seat belt retractor 3 of this example is activated.

As a result, the locking base 13 is prevented from being rotated in the seat-belt withdrawing direction (locked). However, because a withdrawing force acts on the seat belt 4 due to the inertia of the occupant, causing the spool 9 to rotate in the belt-withdrawing direction, the torsion bar 12 is twisted, and only the spool 9 is rotated in the seat-belt withdrawing direction relative to the locking base 13. After this, the spool 9 rotates in the seat-belt withdrawing direction while twisting the torsion bar 12. Then, the torsional torque of the torsion bar 12 absorbs and relaxes the impact energy of the occupant, limiting the load applied to the seat belt 4.

After the spool 9 has rotated in the seat-belt withdrawing direction relative to the locking base 13 by a predetermined amount, the spool 9 also stops rotating relative to the locking base 13. That is, the rotation of the spool 9 in the seat-belt withdrawing direction is locked, preventing further withdrawing of the seat belt 4. Thus, the occupant is restrained by the seat belt 4, and the inertial movement is inhibited.

Meanwhile, in a normal seat belt wearing state (in a state in which the buckle switch is turned on), the ECU 25 controls the motor 16 according to the details of the operating conditions of the MSB function, such as vehicle driving conditions, e.g., driving over a bad road and driving over an ice-covered road, and vehicle operating conditions, e.g., high-speed driving, sports driving, and a sudden braking operation to control the belt tension of the seat belt 4. That is, when the motor 16 is driven in the rotation direction corresponding to the direction in which the spool 9 winds up the seat belt, the motive power of the motor 16 is transmitted to the spool 9 via the power transmission mechanism 18, the torque limiter mechanism 19, and the torsion bar 12. As a result, the spool 9 rotates in the seat belt winding direction and winds up the seat belt 4, increasing the belt tension.

Furthermore, conversely, when the motor 16 is driven in the rotation direction corresponding to the direction in which the seat belt is withdrawn from the spool 9, the motive power of the motor 16 is similarly transmitted to the spool 9, rotating the spool 9 in the seat-belt withdrawing direction. As a result, the seat belt 4 is withdrawn, and the belt tension is reduced.

Next, the configuration and operation of the MSB3 of this example different from the MSB disclosed in the publication of Japanese Patent No. 4379783 will be described.

An MSB3 control device of this example controls the motor current flowing through the motor 16 and the direction in which the motor current flows, according to the details of the operating conditions of the above-described MSB function.

FIG. 4 is a block diagram of the seat-belt-retractor control device of the example shown in FIG. 1.

As shown in FIG. 4, the MSB3 control device of this example further includes a power source 22 for supplying electricity to the motor 16, a driver 23 that controls supply of electricity from the power source 22 to drive the motor 16, and an ammeter 24 that measures the motor current flowing through the motor 16. The driver 23 and the ammeter 24 are both electrically connected to the electric control unit (ECU) 25, which is the control device for the seat belt device 1. The driver 23 controls supply of electricity from the power source 22 to the motor 16, under the on-off control of the ECU 25. The ammeter 24 detects the current of the motor current flowing through the motor 16 and outputs a detection signal to the ECU 25.

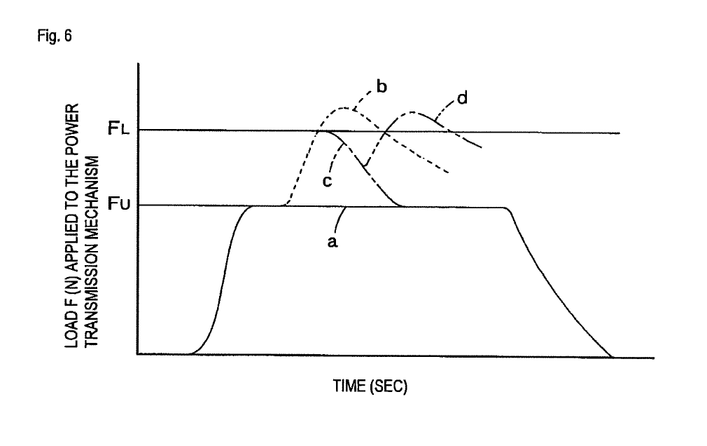

The ECU 25 includes a memory 25a. This memory 25a stores a preset current set in advance and a preset time set in advance as a comparison reference value for the elapsed time from when the seat belt winding utilizing the motive power of the motor 16 is started. In this case, the preset current is set to such a motor current that the seat belt winding load exerted only by the motor, excluding the counter force from the seat belt, is a predetermined value. The load of the power transmission mechanism is smaller than the torque limiter load. For the preset current, for example, the above-described preset current corresponding to the preset load Fu (N), shown in FIG. 6, may be used.

In addition, an MSB-function operating-condition-signal output portion 26 and the buckle switch 27, serving as a tongue-buckle engagement detecting member, are electrically connected to the ECU 25. The MSB-function operating-condition-signal output portion 26 includes, for example, an object detecting sensor; a vehicle-driving-mode-information-signal output portion for outputting information about the driving mode, such as sports driving mode and high-speed driving mode; a collision prediction sensor; and a collision detecting sensor.

The MSB-function operating-condition-signal output portion 26 outputs an MSB-function operating-condition signal to the ECU 25. The ECU 25 determines whether or not the MSB-function operating conditions are satisfied, based on this MSB-function operating-condition signal, and causes the MSB3 to activate the MSB function when it determines that the MSB-function operating conditions are satisfied. That is, the ECU 25 drives the motor 16 by controlling the motor current, thereby selectively performing winding and withdrawing of the seat belt 4. Furthermore, the buckle switch 27 is turned on when it detects that the tongue 6 is inserted into and fastened with the buckle 7 and then outputs a buckle switch-on signal to the ECU 25, and is turned off when engagement between the tongue 6 and the buckle 7 is eliminated and then outputs a buckle switch-off signal to the ECU 25. The ECU 25 determines whether or not the occupant is wearing the seat belt based on the buckle switch-on and buckle switch-on off signals.

The MSB3 control device of this example drives and controls the driver 23 to stop power supply to the motor 16, when the ECU 25 determines that the buckle switch is on, that the seat belt is being wound by activation of the MSB function, and that the motor current is equal to or larger than the preset current. For example, during sudden braking and the like in which a brake pedal is stepped on at a higher brake-pedal stepping speed than during normal braking and in which a vehicle deceleration to an extent activating the ELR function is generated, the load of the seat belt does not increase significantly and the torque limiter mechanism 19 is not activated because power supply to the motor 16 is stopped. In this case, the ELR function is activated, restraining the occupant with the seat belt 4. Therefore, activation of the torque limiter mechanism 19 is suppressed.

Furthermore, in the MSB3 control device, the ECU 25 does not stop power supply to the motor 16 when the buckle switch is on and the motor current is smaller than the preset current during winding of the seat belt by activation of the MSB function. In this case, when a vehicle deceleration to an extent activating the torque limiter mechanism 19 occurs, the load input to the power transmission mechanism due to the load exerted by the seat belt before the motor current reaches the preset current increases to a level exceeding the torque limiter load, activating the torque limiter mechanism 19 and activating the ELR function, thereby restraining the occupant with the seat belt 4. For example, in the case of a collision in which the pretensioner is not activated but the ELR function is activated, the torque limiter mechanism 19 is activated before the motor current reaches the preset current in this manner. Thus, power supply to the motor 16 is not stopped. Then, after the ELR function is activated and the occupant is restrained with the seat belt 4, power supply to the motor 16 is stopped.

Thus, by stopping the power supply to the motor 16 during winding of the seat belt 4 by the motor 16, activation of the torque limiter mechanism 19 is suppressed. Accordingly, the activation frequency of the torque limiter mechanism 19 is reduced.

Note that, in the description of the MSB3 of this example, “activation of the MSB function” means activation of the function for performing winding or withdrawing of the seat belt 4 by rotating the spool 9 by the motor 16. Furthermore, “activation of the ELR function” means, as described above, a locking operation of the pawl 20 of the locking mechanism 11 by activation of the deceleration detecting mechanism 10.

The MSB3 control device of this example assumes that the MSB-function operating conditions are satisfied in the cases where the motor 16 relatively less tightly winds the seat belt 4 to perform a warning operation to warn an occupant, such as a driver, when, for example, the ECU 25 determines that the car is likely to collide with an object positioned in front of the car (a forward vehicle or the like) but can still avoid collision since the car is just approaching the object; where the motor 16 relatively less tightly winds the seat belt 4 to lightly restrain the occupant in a sports driving mode or a high-speed driving mode, when the occupant has changed the driving mode from a normal driving mode in which the occupant is scarcely restrained; where the seat belt 4 is relatively tightly wound to perform a warning operation to warn the occupant, such as the driver, and to perform an emergency operation in which the occupant is restrained with a large restraining force, when the ECU determines that the car has gotten very close to the object positioned in front of the car (a forward vehicle or the like) and that the car does not have enough time to avoid collision and is likely to collide with the object, based on the output signal from the collision prediction sensor or the like; and when the ECU determines that the car has collided with an object (a forward vehicle or the like), based on the output signal from the collision detecting sensor or the like.

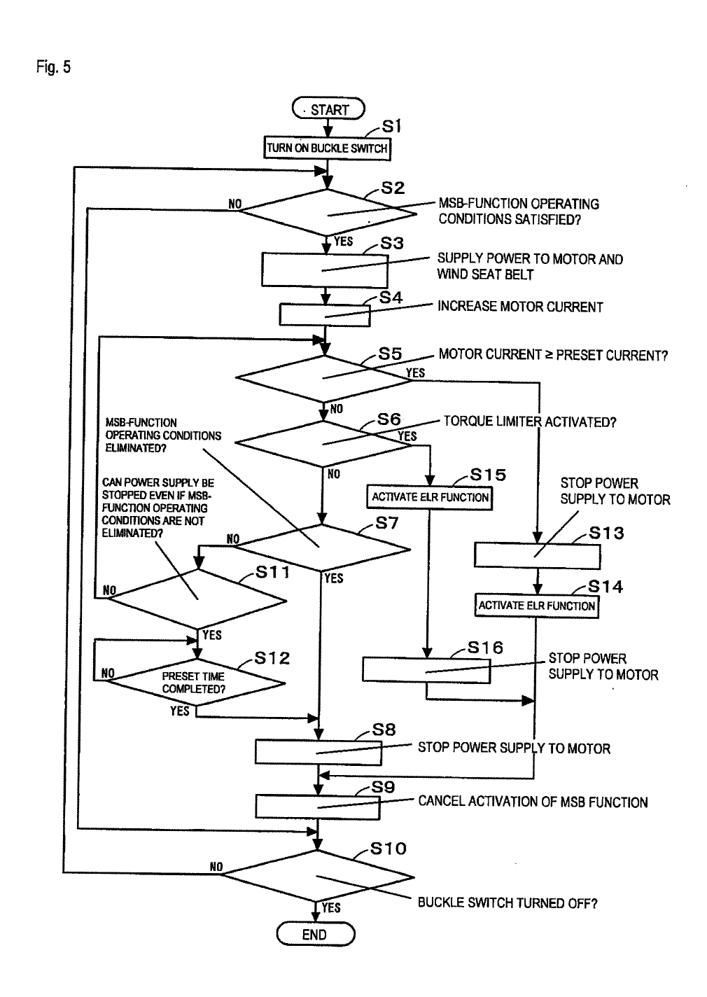

Next, a method for controlling the load applied to the power transmission mechanism 18 by controlling the above-described motor current will be described. FIG. 5 is a diagram showing a flow of a method for controlling the load applied to the power transmission mechanism.

When controlling the load applied to the power transmission mechanism 18, as shown in FIG. 5, in step S1, the tongue 6 is inserted into and fastened with the buckle 7, turning on the buckle switch 27. When the buckle switch 27 is turned on, in step S2, the ECU 25 determines whether or not the MSB-function operating conditions for winding the seat belt 4 are satisfied. When it is determined that the MSB-function operating conditions are satisfied, in step S3, power is supplied to the motor 16, and the seat belt 4 begins to be wound. The motor current of the motor 16 increases due to winding of the seat belt 4 in step S4.

Next, in step S5, whether or not the motor current is equal to or larger than the preset current is determined. If it is determined that the motor current is not equal to or larger than the preset current, in step S6, whether or not the torque limiter mechanism 19 is activated is determined, which determines the subsequent processes. When the torque limiter mechanism 19 is not activated, in step S7, whether or not the MSB-function operating conditions are eliminated is determined. When it is determined that the MSB-function operating conditions are eliminated, in step S8, power supply to the motor 16 is stopped, and in step S9, activation of the MSB function is canceled. When activation of the MSB function is canceled, the motor 16 rotates in the seat-belt withdrawing direction, releasing (disengaging) a clutch of the power transmission mechanism. Then, the seat belt 4 is retuned to an initial normal wearing state (a comfortable state in which the occupant does not feel tightness due to the seat belt). Next, in step S10, whether or not the buckle switch 27 has been turned off is determined. When it is determined that the buckle switch 27 has been turned off, the control of the load applied to the power transmission mechanism 18 is terminated, and wearing of the seat belt is canceled. Furthermore, when it is determined that the buckle switch 27 has not been turned off, the flow proceeds to step S2, and the processing subsequent to step S2 are performed.

In step S7, when it is determined that the MSB-function operating conditions are not eliminated, in step S11, it is determined whether or not power supply to the motor 16 can be stopped without eliminating the MSB operating conditions. In the processing in step S11, power supply to the motor 16 is stopped when, for example, the seat belt 4 is relatively less tightly wound to warn the occupant, as described above, and the warning does not need to last for a period of time equal to or larger than a preset time. Thus, not only the driving time of the motor 16 is reduced, thereby extending the life of the motor 16, but also the energy consumption is reduced. When it is determined that power supply to the motor 16 can be stopped without eliminating the MSB operating conditions, in step S12, it is determined whether or not a preset time has been completed (elapsed). When it is determined that the preset time has not yet been completed (elapsed), the processing in step S12 is repeated. When it is determined that the preset time has been completed (elapsed), the flow proceeds to step S8, and processing subsequent to step S8 is performed. In step S11, if it is determined that power supply to the motor 16 cannot be stopped without eliminating the MSB operating conditions, the flow proceeds to step S5, and processing subsequent to step S5 is performed.

When it is determined that the motor current is equal to or larger than the preset current in step S5, power supply to the motor 16 is stopped in step S13, and the ELR function is activated in step S14. Therefore, the pawl 20 is engaged with the internal gear 21 and the rotation of the spool 9 in the seat-belt withdrawing direction is locked. Thus, when a certain deceleration is applied to the vehicle due to a sudden braking or the like, the occupant is effectively restrained by the seat belt 4. At this time, if a deceleration is applied to the vehicle, the seat belt 4 tends to exert a large load (a counter force) on the power transmission mechanism 18 due to the inertial force of the occupant. However, because of the activation of the ELR function, the seat belt 4 does not exert the load on the power transmission mechanism 18. Then, the flow proceeds to step S9, and the processing subsequent to step S9 is performed. At this time, activation of the MSB function is cancelled as follows: first, the motor 16 is rotated in the seat belt winding direction to release the engagement between the pawl 20 and the internal gear 21 due to the operation of the ELR function, and then, similarly to the above, the motor 16 is rotated in the seat-belt withdrawing direction to release (disengage) the clutch of the power transmission mechanism 18.

In this manner, activation of the torque limiter mechanism 19 is suppressed during winding of the seat belt 4 by the motor 16, and the activation frequency of the torque limiter mechanism 19 is reduced. More specifically, for example, when the load input from the seat belt to the power transmission mechanism during the above-described sudden braking operation or the like is relatively moderate, because the ECU 25 stops power supply to the motor 16, activation of the torque limiter mechanism 19 is suppressed. As a result, compared with the conventional torque limiter mechanism for the motor retractor, which is activated during a sudden braking operation, the activation frequency of the torque limiter mechanism 19 is reduced.

When the torque limiter mechanism 19 is activated in step S6, the ELR function is activated in step S15, restraining the occupant with the seat belt 4. Then, after power supply to the motor 16 is stopped in step S16, the flow proceeds to step S9, and the processing subsequent to step S9 is performed. A case like this, where the motor current is smaller than the preset current and the torque limiter mechanism 19 is activated, is, for example, a case where a collision occurs immediately after starting winding of the seat belt 4 by the motor 16 and the load input from the seat belt 4 to the power transmission mechanism is extreme. In this case, activation of the torque limiter mechanism 19 prevents a large load from acting on the power transmission mechanism and the motor 16, whereby the power transmission mechanism and the motor 16 are protected.

The control device for the seat-belt-retractor 3 of this example drives and controls the driver 23 to stop power supply to the motor 16, when the ECU 25 determines that the buckle switch is on, that the seat belt is being wound by activation of the MSB function, and that the motor current is equal to or larger than the preset current. Thereafter, the ELR function is activated. This prevents a large load from the seat belt from being input to the power transmission mechanism 18, whereby it is possible to prevent a load equal to or larger than the torque limiter load from being input to the power transmission mechanism 18, and it is possible to prevent activation of the torque limiter mechanism 19. Accordingly, the activation frequency of the torque limiter mechanism 19 can be reduced compared with the conventional torque limiter mechanism, which is activated by an excessive force (a counter force) from the seat belt acting on the power transmission mechanism due to the inertial force of the occupant, when the seat belt 4 is relatively tightly wound to perform an emergency operation, such as a sudden braking operation.

Because it is possible to effectively reduce the activation frequency of the torque limiter mechanism 19, the durability of the torque limiter mechanism 19 can be improved. Thus, the compact torque limiter mechanism 19 can be produced at low cost.

Meanwhile, according to the seat belt device 1 having the control device for the seat-belt-retractor 3 of this example, because the durability of the torque limiter mechanism 19 is improved, long-term effective restraining of occupants depending on the situation becomes possible. Furthermore, because the torque limiter mechanism 19 can be made compact, the seat belt retractor 3 can also be made compact. Thus, the arrangement flexibility of the seat belt retractor 3 in the vehicle compartment can be improved.

Note that, the seat-belt-retractor control device of the present invention is not limited to the examples of the above-described embodiment, and the design thereof can be variously modified within the technical scope described in the claims.

### Industrial Applicability

The seat-belt-retractor control device and the seat belt device having the same of the present invention relate to a technical field of a control device for a seat belt retractor that is configured as a motor retractor for performing winding and withdrawing of a seat belt by transmitting the motive power of a motor to a spool via a power transmission mechanism and a torque limiter and that protects the power transmission mechanism and the motor by blocking a load equal to or larger than a predetermined value (a counter force) exerted by the seat belt with the torque limiter, and a seat belt device having the same.

The priority application, Japanese Patent Application Number 2010/103899, filed on Apr. 28, 2010 is incorporated by reference herein.

### Reference Signs List

1: seat belt device, 3: seat belt retractor, 4: seat belt, 6: tongue, 7: buckle, 8: frame, 9: spool, 10: deceleration detecting mechanism, 11: locking mechanism, 12: torsion bar, 13: locking base, 14: pretensioner, 15: spring unit, 16: motor (electric motor), 18: power transmission mechanism, 19: torque limiter mechanism, 20: pawl, 24: ammeter, 25: electric control unit (ECU), 26: MSB-function operating-condition-signal output portion, and 27: buckle switch.

1. A seat-belt-retractor comprising at least:
a spool on which a seat belt is wound; a locking mechanism that normally allows the spool to rotate in seat-belt winding/withdrawing directions and locks the rotation of the spool in the seat-belt withdrawing direction in an emergency;
a motor that rotates the spool by motive power to control the tension of the seat belt; a power transmission mechanism that transmits the motive power of the motor to the spool; and a torque limiter mechanism that is activated when the load input to the power transmission mechanism exceeds a torque limiter load set in advance and blocks transmission of the power by the power transmission mechanism; and
a seat belt-retractor control device having an emergency locking function that locks withdrawing of the seat belt with the locking mechanism in an emergency and a seat-belt tension-control function that performs winding and withdrawing of the seat belt by the motor during the tension control of the seat belt,
wherein the seat-belt-retractor control device includes, at least:
a tongue-buckle engagement detecting member that detects the engagement between a tongue and a buckle;
an ammeter that detects the motor current flowing through the motor;
a seat-belt tension-control-function operating-condition-signal output portion that outputs a seat-belt tension-control-function operating-condition signal; and
a control unit that controls power supply to the motor, and
wherein the control unit stops power supply to the motor when it determines that the tongue-buckle engagement detecting member has detected engagement between the tongue and the buckle, that the seat-belt tension-control function is operating according to the output signal from the seat-belt tension-control-function operating-condition-signal output portion, and that the motor current detected by the ammeter is equal to or larger than the preset value set in advance.

2. A seat belt device for restraining an occupant comprising, at least: a seat-belt-retractor control device that includes a seat belt retractor for winding a seat belt, and a control unit for controlling the seat belt retractor; a tongue supported in a freely slidable manner by the seat belt withdrawn from the seat belt retractor; and a buckle with which the tongue is engaged in an attachable/detachable manner,
wherein the seat belt retractor comprises:
a spool on which a seat belt is wound; a locking mechanism that normally allows the spool to rotate in seat-belt winding/withdrawing directions and locks the rotation of the spool in the seat-belt withdrawing direction in an emergency;
a motor that rotates the spool by motive power to control the tension of the seat belt; a power transmission mechanism that transmits the motive power of the motor to the spool; and a torque limiter mechanism that is activated when the load input to the power transmission mechanism exceeds a torque limiter load set in advance and blocks transmission of the power by the power transmission mechanism; and
wherein the seat belt-retractor control unit includes an emergency locking function that locks withdrawing of the seat belt with the locking mechanism in an emergency and a seat-belt tension-control function that performs winding and withdrawing of the seat belt by the motor during the tension control of the seat belt, wherein the seat-belt-retractor control unit includes, at least:
a tongue-buckle engagement detecting member that detects the engagement between a tongue and a buckle;
an ammeter that detects the motor current flowing through the motor;
a seat-belt tension-control-function operating-condition-signal output portion that outputs a seat-belt tension-control-function operating-condition signal; and
a control unit that controls power supply to the motor, and
wherein the control unit stops power supply to the motor when it determines that the tongue-buckle engagement detecting member has detected engagement between the tongue and the buckle, that the seat-belt tension-control function is operating according to the output signal from the seat-belt tension-control-function operating-condition-signal output portion, and that the motor current detected by the ammeter is equal to or larger than the preset value set in advance.
